(19) United States
(12) Patent Application Publication
(10) Pub. No.: US 2007/0176849 A1
(43) Pub. Date: Aug. 2, 2007

(54) MAGNIFYING VIEWING APPARATUS

(75) Inventors: Jack W. Renforth, Aurora, CO (US); Neil Werde, Broomfield, CO (US); George H. Schwenzfeger, Smithtown, NY (US); Doug Berry, Elkin, NC (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Aspen Pet Products, Inc., Denver, CO (US)

(21) Appl. No.: 11/668,363

(22) Filed: Jan. 29, 2007

Related U.S. Application Data
(60) Provisional application No. 60/762,666, filed on Jan. 27, 2006.
(60) Provisional application No. 60/774,424, filed on Feb. 17, 2006.

(51) Int. Cl. G09G 5/00

(52) U.S. Cl. 345/7

(57) ABSTRACT

An apparatus for viewing an environment. The environment may be, for example, water inside a fish tank, the interior of a pet cage or habitat, or simply a room divided by a wall or window. The apparatus includes a first viewing piece defining a first viewport. The apparatus may further include a second viewing piece defining a second viewport with the first and second viewing pieces operably connected by a bracket or magnets. One of the viewing pieces magnifies at least a portion of the environment, and the first viewport may at least partially aligns with the second viewport. A line with a stay may be connected to the one of the viewpieces for maintaining the viewing apparatus in a stationary position relative to the environment. The stay may be an anchor or a suction cup for attachment to a partition, such a fish tank or pet cage wall, at least partially defining the environment.

### CROSS-REFERENCE TO RELATED APPLICATIONS

This application claims, under 35 U.S.C. §119(e), the benefit of U.S. Provisional Application No. 60/762,666, entitled “Magnifying Viewing Apparatus” and filed Jan. 27, 2006 and U.S. Provisional Application No. 60/774,424, entitled “Magnifying Viewing Apparatus” and filed Feb. 17, 2006; which are hereby incorporated by reference herein in their entireties.

### BACKGROUND OF THE INVENTION

1. Technical Field

The present invention relates generally to a viewing device, and more particularly to an apparatus for viewing and magnifying at least a portion of the environment.

2. Background Art

Many people have fish tanks or other pet enclosures. Oftentimes, people may wish to view the interior of such an enclosure to check on their pets, other objects within the environment (such as food, water, toys, or decoration), and so forth. It may be inconvenient to enter the environment or open the enclosure, especially where the environment is aquatic.

The enclosure may be at least partially defined by a partition. For example, if the enclosure is a fish tank, a glass wall forms part of the tank and is a partition between the interior environment (i.e., the water) and exterior environment (air). Especially in the case of small enclosures, viewing objects or the interior of the environment may prove difficult. This may be compounded where the environment distorts or alters viewing inside the enclosure, as in the case of water.

Accordingly, there is a need in the art for an improved apparatus for viewing the interior of an environment.

### SUMMARY OF THE INVENTION

Generally, one embodiment of the present invention may take the form of an apparatus for viewing an environment. The environment may be, for example, water inside a fish tank, the interior of a pet cage or habitat, or simply a room divided by a wall or window.

The apparatus may consist, for example, of a first viewing piece and a second viewing piece. The first and second viewing pieces may be separated in order to be placed on opposing sides of a partition separating the viewed environment from a viewer. For example, the viewer may stand outside an environment contained by a cage or glass wall at least partially defined by the partition.

Both the first and second viewing pieces may include a viewport. For example, the first viewing piece may have a first viewport and the second viewing piece may have a second viewport. At least one of the first and second viewports may magnify an object within the environment so that a viewer looking through the magnifying viewport sees an enlarged version of object within the environment (or a portion of the environment).

The first viewing piece may be placed on an outside of the partition and the second viewing piece on an inside of the partition. The first and second viewing pieces may be aligned on opposing sides of the partition, such that the first and second viewports are at least partially aligned. Thus, regardless of whether the first or second viewport is the magnifying viewport, a viewer looking through the embodiment when the first and second pieces are aligned will see a magnified view of the environment or object.

Another embodiment of an apparatus for viewing an environment may take the form of a first viewing piece, a line connected the first viewing piece, and a stay connected to the line. The first viewing piece may define a first viewport and magnify at least a portion of the environment. The stay may be selectively connectable to a partition at least partially defining the environment. The line and stay may maintain the first viewing piece in a stationary position relative to the partition.

The first and second viewing pieces may be of any size or shape. For example, in one embodiment, the first and second viewing pieces may both be round. It should be noted that the first and second viewing pieces need not necessarily be of the same size and/or shape.

### BRIEF DESCRIPTION OF THE FIGURES

FIG. 1 is a front view of a first viewing piece, in accordance with an embodiment of a viewing apparatus.

FIG. 2 is a cross-sectional view of the first viewing piece of FIG. 1, viewed along line 2-2 of FIG. 1.

FIG. 3 is a front view of a second viewing piece, in accordance with an embodiment of the viewing apparatus.

FIG. 4 is a cross-sectional view of the second viewing piece of FIG. 3, viewed along line 4-4 of FIG. 3.

FIG. 5 is a front view of a second embodiment of a second viewing piece.

FIG. 6 is a cross-sectional view of the second viewing piece of FIG. 5, viewed along line 6-6 of FIG. 5.

FIG. 7 is a front view of a third embodiment of a second viewing piece.

FIG. 7A is a cross-sectional view of the second viewing piece of FIG. 7, viewed along line 7A-7A of FIG. 5.

FIG. 8 is a top view of the second viewing piece of FIG. 7.

FIG. 9 is a front view of an embodiment of a bracket and a first viewing piece.

FIG. 10 is a right side view of the bracket and first viewing piece of FIG. 9, which also shows an embodiment of the second viewing piece.

FIG. 11 is a cross-sectional of the bracket with the first viewing piece and the second viewing piece, viewed along line 11-11 in FIG. 9.

FIG. 12 is a view showing the bracket supporting the first and second viewing pieces, the first viewing piece located outside an environment defined by a partition and the second viewing piece within the environment.

FIG. 13 is a front perspective viewing of an embodiment of a bracket with first and second viewing pieces, the bracket mounted on a partition.

FIG. 14 is an exploded front perspective view of the bracket with first and second viewing pieces of FIG. 13.

FIG. 15 is a front perspective view of another embodiment of the viewing apparatus.

FIG. 16 is a front perspective view of the two embodiments depicted in FIG. 15 placed within an environment defined by a partition, each embodiment showing a line extending a different length.

FIG. 17A is a front perspective view of yet another embodiment of the present invention, particularly showing the first viewing piece.

FIG. 17B is a rear perspective view of yet another embodiment of the present invention, particularly showing the second viewing piece.

FIG. 18 is a front elevation view of the embodiment shown in FIGS. 17A and 17B.

FIG. 19 is a cross-sectional view of the embodiment shown in FIGS. 17A and 17B, viewed along line 19-19 in FIG. 18.

FIG. 20 is a cross-sectional view of the embodiment shown in FIGS. 17A and 17B, viewed along line 20-20 in FIG. 18.

FIG. 21 is an exploded perspective view of the embodiment shown in FIGS. 17A and 17B.

### DETAILED DESCRIPTION OF THE INVENTION

Generally, one embodiment of the present invention may take the form of an apparatus for viewing an environment. The viewing apparatus may consist, for example, of a first viewing piece and a second viewing piece. The first and second viewing pieces may be separated by a select distance for placement on opposing sides of a partition separating the viewed environment from a viewer. For example, the viewer may stand outside an environment at least partially defined by the partition, such as a cage or glass wall.

Both the first and second viewing pieces may include a viewport, such as a lens. For example, the first viewing piece may have a first viewport or lens and the second viewing piece may have a second viewport or lens. At least one of the first and second viewports may magnify an object within the environment so that a viewer looking through the magnifying viewport sees an enlarged version of object within the environment (or a portion of the environment).

The first viewing piece may be placed on an outside of the partition and the second viewing piece on an inside of the partition. The first and second viewing pieces may be aligned on opposing sides of the partition, such that the first and second viewports are at least partially aligned. Thus, regardless of whether the first or second viewport is the magnifying viewport, a viewer looking through the embodiment when the first and second pieces are aligned will see a magnified view of the environment or object.

The first and second viewing pieces may be of any size or shape. For example, in one embodiment, the first and second viewing pieces may both be round. However, the first and second pieces need not necessarily be of the same size and/or shape, and may be any desired size or shape.

In one exemplary embodiment, the first viewing piece may include a first clear sheet of glass, plastic, Plexiglas, a transparent polymer, or the like. This sheet may have a shape and/or size generally matching that of the first viewing piece. The first sheet may be circular, for example.

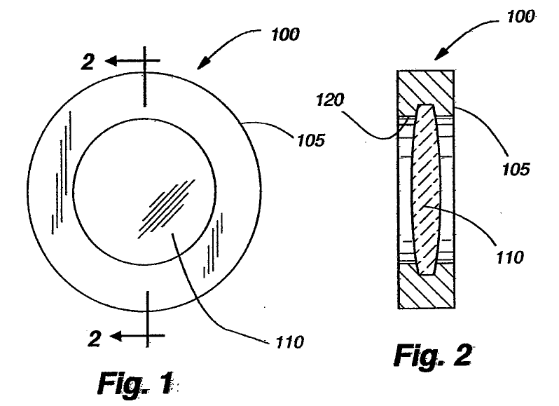

With reference to FIGS. 1 and 2, the first viewing piece 100 may include a first casing 105 at least partially encircling a first sheet 110. The first casing 105 may be a toroid or doughnut shape, for example, with the opening therein defining the first viewport. The first sheet 110 may extend across this viewport. That is, the first casing 105 may be a hollow cylinder, with the interior hollow defining the viewport and the first sheet 110 extending across the hollow, for example along a plane running through the interior of the hollow or the base of the hollow. The first sheet 110 may be clamped to, received within, adhered to, welded, or otherwise affixed or joined to the first casing 105. For example, FIG. 2, which is a cross-sectional view viewed along line 2-2 of FIG. 1, shows the first sheet 110 received within the first casing 105. Alternatively, the first sheet 110 may be affixed or joined to an exterior portion of the first casing 105, such as the casing's front or rear side, or to an interior portion of the casing 105, such as the hollow. As another example, the first sheet 110 may extend partially into or through one or more sidewalls 120 of the first casing 105. For example, the first sheet 110 may extend through the inner sidewall 120 of a cylindrically-shaped first casing 105 (i.e., through the sidewall 120 defining the interior hollow). The fitting between the first sheet 110 and first casing 105 may be sufficiently snug that the first sheet 110 will not move when received by the first casing 105. Alternatively, and as mentioned above, the first sheet 110 may be affixed to the first casing 105 with an adhesive or by heat or sonic welds. The first casing 105 may be formed from a variety of materials, including, but not limited to, plastic, Plexiglas, glass, metal, metal alloy, ceramic, a polymer, and so forth.

In yet another embodiment, the first casing 105 may be omitted. The first sheet 110 may be cast or formed in such a manner that a segment of the first sheet 110 is thickened or expanded to take the place of the first casing 105. Thus, the aforementioned hollow cylinder with the first sheet 110 extending across a portion of the hollow, such as an interior plane or the base of the hollow, may be created as a unitary element out of the material used to form the first sheet 110.

The first viewing piece 100 may include decorative elements designed to create a specific appearance. For example, the first casing 105, or the first sheet 110 may have studs, hinges, and so forth attached thereto or integrally formed thereon, to create the appearance of a porthole or ship's window.

Similar to the first viewing port, the second viewing port may include a second casing and a second viewing sheet. As with the first viewing port, the second sheet may be affixed to, partially enclosed by, or otherwise attached to the second casing.

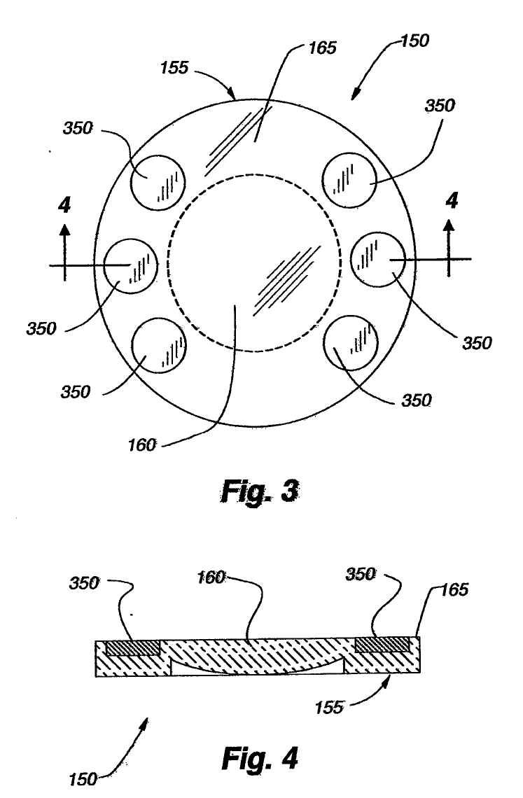

In many embodiments, however, the second casing is omitted entirely. FIG. 3, for example, is a front view of a second viewing piece 150 omitting the second casing. Here, the second sheet 155 forms both an interior lens 160 and an outer cylindrical support 165. As seen in the cross-sectional view of FIG. 4, viewed along line 4-4 of FIG. 3, the lens 160 and outer support 165 may be formed from the same material and comprise a single piece. In some embodiments, however, the second viewing piece 150 may be formed from multiple pieces suitably joined together to form a unitary piece. Thus, there is no casing about the lens, insofar as the lens 160 extends through the support to the outer edge of the second sheet 155 and no separate component overlies or surrounds the lens 160.

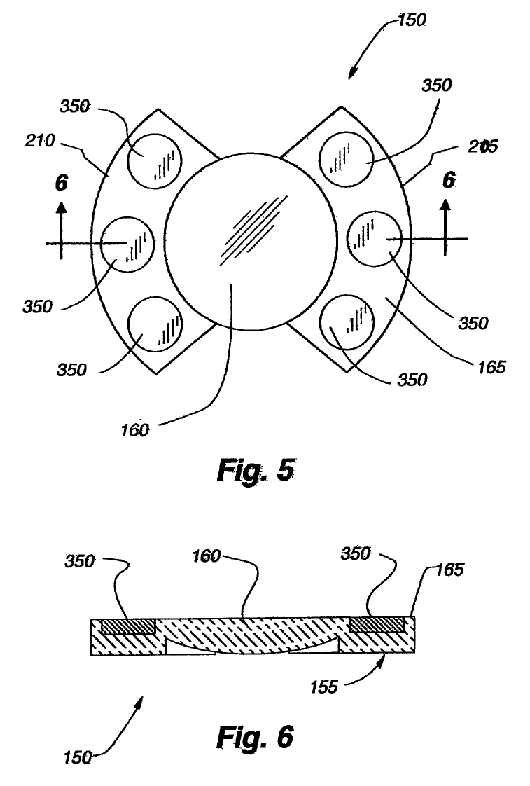

FIG. 5 depicts an alternative embodiment of the second viewing piece 150 where like numbers are used for similar elements. In this embodiment, the outer support 165 is partially cut away when compared to the support 165 shown in FIG. 3. Essentially, a first and a second arcuate wing replace the cylindrical support 165. The first and second arcuate wings may be formed at opposing edges of the lens or second sheet 160. As shown in FIG. 6, which is a cross-sectional view viewed along line 6-6 of FIG. 5, the wings 205, 210 and lens 160 may be formed as a single piece. However, as with the embodiment depicted in FIG. 3, the second viewing piece may in some embodiments be formed from multiple pieces suitably joined together to form a unitary piece. Also, the support 165 may have no more or less than two wings as shown in FIGS. 5 and 6. Further, the wings may be any other suitable or desired shape.

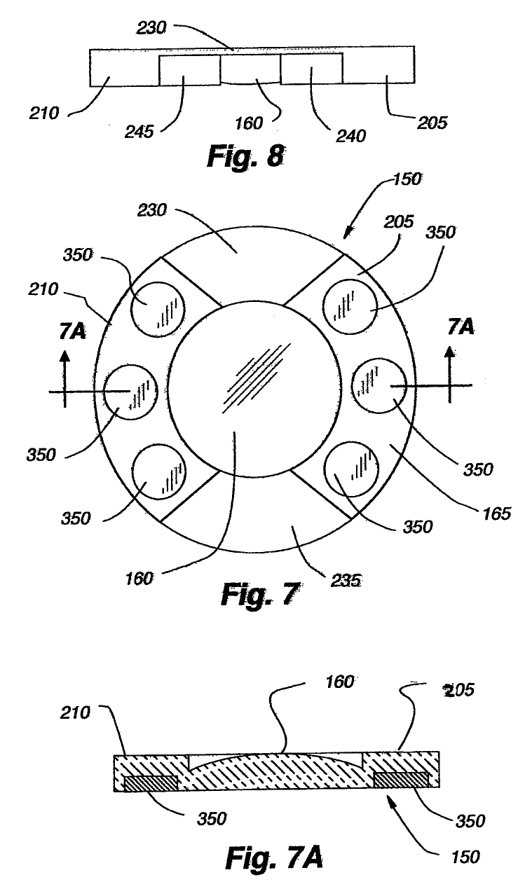

FIGS. 7 and 8 depict yet another embodiment of the second viewing piece 150 where like numbers are used for similar elements. Again, the second viewing piece 150 includes a lens 160, a first arcuate wing 205 and a second arcuate wing 210. The first and second wings 205, 210 are connected to one another not only by the lens 160, but also by first and second semicircular disc segments 230, 235. The disc segments 230, 235 may be thinner (e.g. have less depth) than the lens 160 and/or wings 205, 210. FIG. 8, for example, is a top view of the second viewing piece 225 shown in FIG. 7. The first disc segment 230 is shown connecting the first wing 205 to the second wing 210. Further, the inwardly-sloping sidewalls 240, 245 of the first and second wings 205, 210 may be seen. As with the embodiments of FIGS. 3-6, the embodiment of the second viewing piece 150 shown in FIGS. 7 and 8 is generally formed as a unitary piece. However, in some embodiments, the second view piece may be formed from multiple pieces suitably joined together to form a unitary piece.

The lens 160 of the second viewing piece 150 is typically convex for magnifying objects in the environment, or a portion of the environment. In some embodiments, the first sheet 110 may be convex and the lens 160 of the second sheet 155 flat. In yet other embodiments, both the first sheet 110 and the lens 160 of the second sheet 155 may be formed into convex lenses.

Additionally, the lens, whether formed as part of the first sheet 110, second sheet 155, or both, may be curved on both its front side and back side as opposed to having a flat back side, as shown, for example, in FIG. 4.

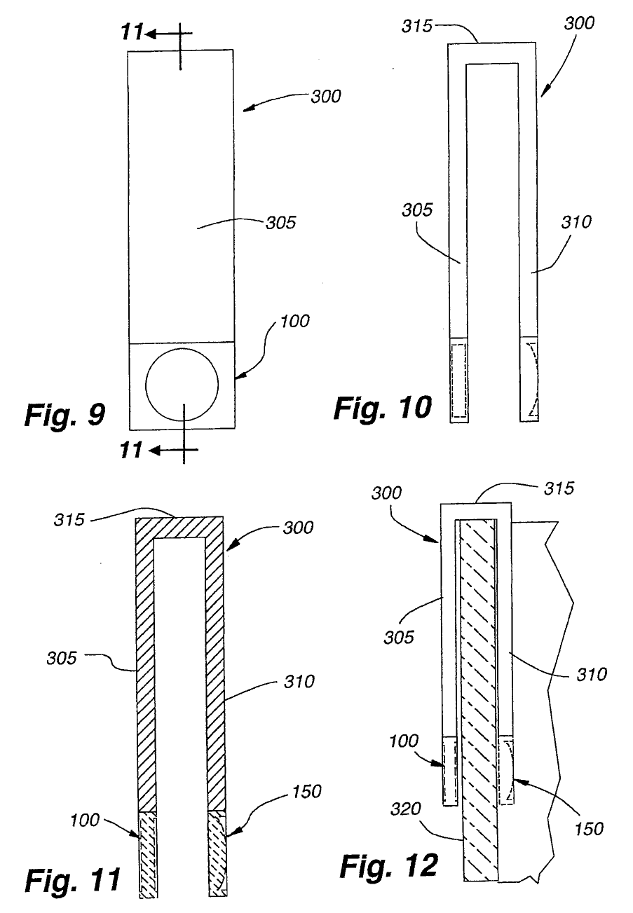

To align the first and second viewing pieces 100, 150, some aligning apparatus or mechanism must be provided. For example, the first and second viewing pieces may be connected by a C-shaped or U-shaped bracket 300. One such bracket 300 is shown in front view in FIG. 9 and side view in FIG. 10. The bracket 300 may have a first arm 305, a second arm 310, and a back 315 connecting the first and second arms 305, 310. Alternatively, the back 315 may be omitted and the first and second arms 305, 310 directly connected to one another. Using the bracket 300, the first viewing piece 100 may be placed on an outside of the partition 320 and the second viewing piece 150 on the inside of the partition 320 as depicted in FIG. 12. As shown in FIGS. 11, 13 and 14, the first arm 305 may be attached, either removably or non-removably, to the first viewing piece 100, and the second arm 310 may be removably or non-removably attached to the second viewing piece 150. The back 315 may stabilize and align the first and second arms 305, 310, and thus maintain the relative positioning of the first and second viewing pieces 100, 150.

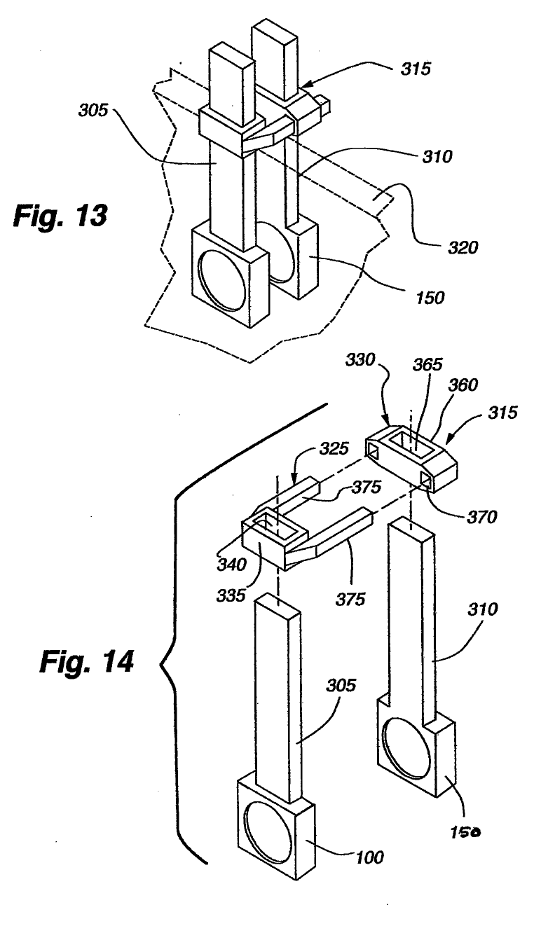

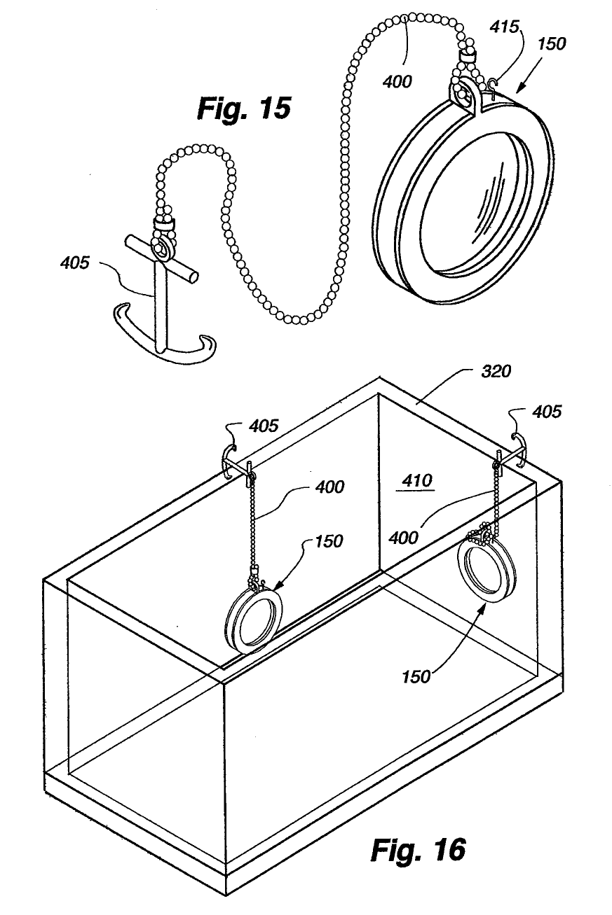

The back 315 may be composed of the single piece of material as shown in FIG. 11, or composed of two or more pieces of material as shown in FIGS. 13 and 14. As shown in FIGS. 13 and 14, the back 315 may include a first back piece 325 and a second back piece 330. The first back piece 325 may be formed with a first back body 335 defining a first arm aperture 340 for receiving the first arm 305. The distance between the first viewing piece 100 and the back 315 may be selectively changed by sliding the first arm 305 through the first arm aperture 340. As the first arm 305 is slid upwardly or downwardly through the first arm aperture 340, the distance between the first viewing piece 100 and the back 315 decreases or increases respectively. As the distance between the first viewing piece 100 and the back 315 decreases or increases, the distance the first viewing piece 100 extends from the top of a partition 320 decreases or increases, respectively, when the back 315 rests on the partition 320 as shown in FIG. 13, thus allowing a user to adjust the elevation of the first viewing piece 100 relative to the viewing environment.

Similar to the first back piece 332, the second back piece 330 may be formed from a second back body 360 defining a second arm aperture 365 for receiving the second arm 310. Like the first viewing piece 100, the distance between the second viewing piece 150 and the back 315 may be changed by sliding the second arm 310 through the second arm aperture 365. Similarly, as the distance between the second viewing piece 150 and the back 315 decreases or increases, the distance the second viewing piece 150 extends from the top of the partition 320 decreases or increases, respectively, thus allowing a user to adjust the elevation of the second viewing piece 150 relative to the viewing environment.

The first and second arm apertures 340, 365 may be sized to receive the first and second arms 305, 310 and frictionally or mechanically prevent the first and second viewing pieces 100, 150 from moving relative to the back 315 unless the first and second viewing pieces 100, 150 are selectively moved by the user. Alternatively, the first back piece 325, the second back piece 330, or both may include a hole or holes for receiving a locking device, such as a screw or the like, to selectively engage or disengage the first arm 305 and/or the second arm 310 to prevent or allow movement of the first and second viewing pieces 100, 150 relative to the back 315.

A pair of back adjustment apertures 370 may be formed in the second back body 360 and receive back adjustment arms 375 extending from the first back body 335. As the back adjustment arms 375 are slid forwardly and rearwardly through their respective back adjustment apertures 370, the distance between the first back body 335 in the second back body 330 decreases and increases respectively, thus changing the distance between the first viewing piece 100 and the second viewing piece 150. Selectively changing the distance between the first and second viewing pieces 100, 150 allows the viewing apparatus to be used with partitions 320 having different thicknesses.

Like the first and second arm apertures 340, 365, the back adjustment apertures 370 may be sized to fractionally receive the back adjustment arms 375 and prevent the first and second viewing pieces 100, 150 from moving towards or away from each other unless the first and second viewing pieces 100, 150 are selectively moved by the user. Similarly, the second back piece 330 may include a hole or holes for receiving a back adjustment locking device, such as a screw or the like, to selectively engage or disengage at least one of the back adjustment arms 375 to prevent or allow movement of the first and second viewing pieces 100, 150 towards or away from each other.

In operation, the first and second viewing pieces 100, 150 may be positioned relative to each other by sliding the back adjustment arms 375 within the back adjustment apertures 370 to receive the partition 320 between the arms. The distance each viewing piece 100, 150 extends from the top of the partition 320 may be adjusted by sliding the respective arm 305, 310 up or down through its respective arm aperture 340, 365. A user may position the first and second viewing pieces 100, 150 to generally align as shown in FIG. 13. However, if desired, the user may position the first and second viewing pieces 100, 150 so that they do not align.

The first arm and the second arm may each be composed of a single piece of material as shown in FIGS. 13 and 14. Alternatively, the first arm and the second arm may each be composed of multiple segments joined together to form the first and second arm respectively. The first arm segments may be designed to nest into each other in order to allow the first arm to telescope from a retracted position to an extended position. Similarly, the second arm segments may be designed to nest into each other to allow the second arm to extend from a retracted position to an extended position. By telescoping the first and second arm segments into each other, the first arm and the second arm may be adjusted from a retracted position to an extended position thereby allowing for the adjustment of the first viewing piece and the second viewing piece relative to the back. Such adjustment may be used to adjust the position that the first viewing piece and/or the second viewing piece extends from the upper edge of the partition thereby allowing the user to adjust the elevation of the viewing pieces relative to the viewing environment.

As an alternative, a portion of either the first or the second viewing piece 100, 150 may be made of a metal, and magnets may be placed in the other viewing piece 150, 100. For example, the casing 105 of the first viewing piece 100 may be made from metal, and at least one magnet 350 may be placed in the second viewing piece 150. Continuing the particular example, FIGS. 3, 5 and 7 depict six magnets 350 placed in the outer support 165 or wings 205, 210. For the embodiment depicted in FIG. 5, three magnets 350 may be placed in each wing 205, 210. As another example, one of first or second viewing pieces 100, 150 may have at least a portion made of metal, and the other may have at least a portion made of magnetic material.

The exact positioning of the magnets 350 may vary. The embodiments of FIGS. 3, 5 and 7 depict the back of the magnets 350 as approximately level with the back of the second viewing piece 150. However, the magnets 350 may be positioned with their fronts level with the front of the viewing piece, the magnets 350 may be surrounded by the viewing piece, the magnets 350 may surround an outer surface or a portion of the viewing piece, or some combination thereof. Similarly, the viewing piece(s) 100, 150 may be formed around the magnet or magnets 350, or one or more apertures may be formed in the viewing piece(s) 100, 150 to permit insertion of the magnets 350. The magnets 350 may be joined to the viewing pieces 100, 150 by mechanical fasteners, adhesives, heat or sonic welds, any other method for joining elements together, or by any combination thereof.

The magnet or magnets 350 may attract the metal, or other suitable material, of the first viewing piece's casing 105. This magnetic attraction may be exerted between the first and second viewing pieces 100, 150 while they are on opposing sides of the environment's partition 320. Further, the magnetic attraction, coupled with a friction between the partition 320 and the first viewing piece 100 and the partition 320 and the second viewing piece 150, may serve to hold the viewing pieces 100, 150 in relative alignment to one another and at a particular point on the partition 320.

Additionally, the magnetic attraction of the second viewing piece 150 to the first viewing piece 100 may be sufficiently strong that the second viewing piece 150 may slide along the interior of the partition 320 as the first viewing piece 100 moves along the exterior of the partition 320. In this manner, the positioning of the second viewing piece 150 along the partition 320 may be controlled by, and subject to, the motion of the first viewing piece 100. This may permit a viewer to move both the first and second viewing pieces 100, 150 to change the portion of the environment (or object within the environment) magnified by the device.

FIG. 15 depicts an alternative embodiment of the viewing apparatus with like numbers used for similar elements similar to those in other embodiments. In this embodiment, the outer viewing piece (i.e., first viewing piece) may be omitted. The second or inner viewing piece 150 may be of any type described herein, and may include decorative elements as discussed above. A line 400, such as a rope, chain, or the like, may be affixed to the inner viewing piece 150, and a stay 405 affixed to the end of the line 400 opposite the connection between line 400 and inner viewing piece 150. The stay 405 may be configured to attach to a portion of the partition 320, such as an upper edge, as shown in FIG. 16.

When the stay 405 is attached to the partition 320, the inner viewing piece 150 may be placed inside the environment adjacent the partition's interior surface 410 as shown in FIG. 16, or may be placed outside the environment adjacent the partition's exterior surface. The line 400 may extend from the stay 405 into the environment. The combination of stay 405 and line 400 may maintain the inner viewing piece 150 in a fixed position with respect to the partition 320, thus permitting a viewer to look through the inner viewing piece 150 and see a magnified section of the environment.

The stay 405 may take a variety of forms. For example, and as depicted in FIGS. 15 and 16, the stay 405 may be a catch, hook, or anchor that catches on an upper edge of the partition 320. Alternatively, the stay 405 may take the form of a suction cup or a magnet that sticks to the partition 320.

The line 400 may have an adjustable length between the inner viewing piece 150 and the stay 450 such that the inner viewing piece 150 may be moved vertically with respect to the partition 320. As an example, the inner viewing piece 150 or the stay 405 may include a hook 415, clip or the like for attachment with the line 400 to vary the effective distance along the line 400 between the inner viewing piece 150 and the stay 405 as shown in FIG. 16. As yet another example, the line 400 may be connected to a winch or the like, joined, for example, to the stay 405 or inner viewing piece 150, and selectively wrapped and unwrapped from the winch or the like to change the length of the line 400 between the inner viewing piece 150 and the stay 405. The foregoing examples are merely illustrative and any other known mechanism may be used to adjust the effective length of the line 400 between the inner viewing piece 150 and the stay 405.

The embodiment of FIG. 15 generally permits a viewer to retrieve the inner viewing piece 150 without putting their hand (or any other portion of their body) into the environment. The viewer may pick up the stay 405 and pull the inner viewing piece 150 out of the environment.

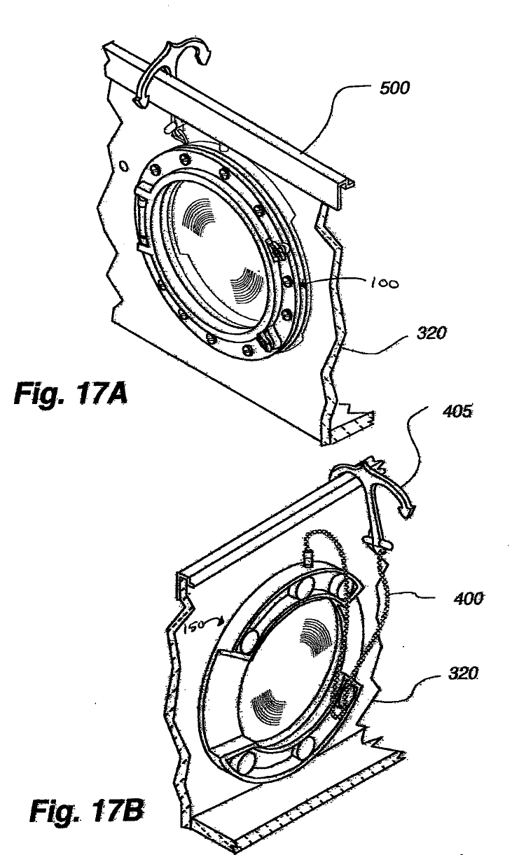

FIGS. 17-21 depict yet another alternative embodiment of the present invention with like numbers used for elements similar to those in other embodiments. The present embodiment may share certain characteristics with previously-described embodiments. Further, any or all of the features or elements described with respect to FIGS. 17-21 may be employed with other embodiments described herein. For example, previously-described embodiments may employ a Fresnel lens.

FIGS. 17A and 17B are front and rear perspective views of the present embodiment mounted to a partition 320 separating an environment from a user. The embodiment may include a first viewing piece 105, generally circular in shape, and a second viewing piece 150. As shown in FIGS. 17A and 17B, the environment is generally visible through the interiors of the first and second viewing pieces 100, 150.

The first viewing piece 100 may generally similar to the first viewing piece described above with respect to FIG. 2, and the second viewing piece 150 may be generally similar to the second viewing piece described above with respect to FIG. 5. The first viewing piece 100 may, however, lack any first sheet. Alternatively, the first sheet may be affixed to (or received within) a hinged window frame 500.

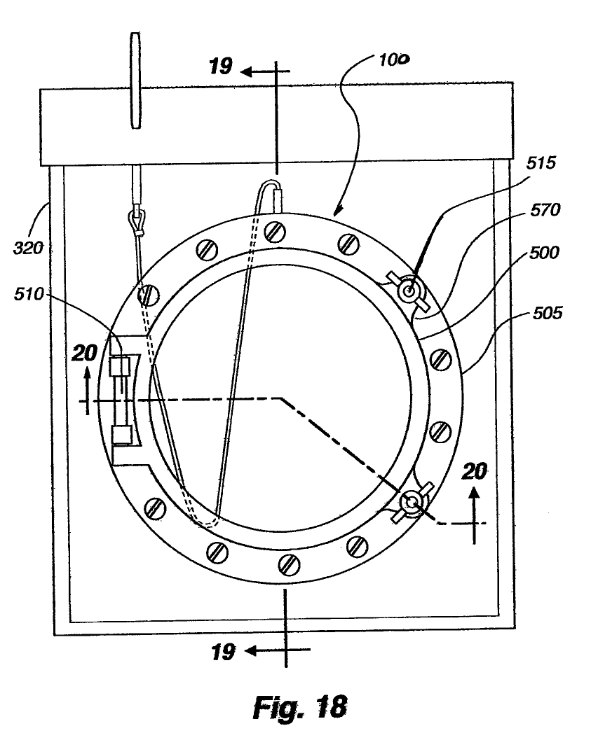

As shown best in FIG. 18, the hinged window frame 500 may be attached to a first base 505 by a hinge 510 joined to a hinge bar 512. Additionally, one or more wing nut studs 515 may project from the first base 505 and through one or more stud receiving holes 514 defined in the window frame 500. Wing nuts 520 joined to the studs 515 may aid in securing the window frame 500 to the first base 505. Further, the wing nuts 520 may be turned or rotated to disengage from the studs 515, thus permitting the window frame 500 to rotate about the hinge bar 512 and at least partially away from the first base 505. In this manner the window frame 500 may be opened much like a porthole.

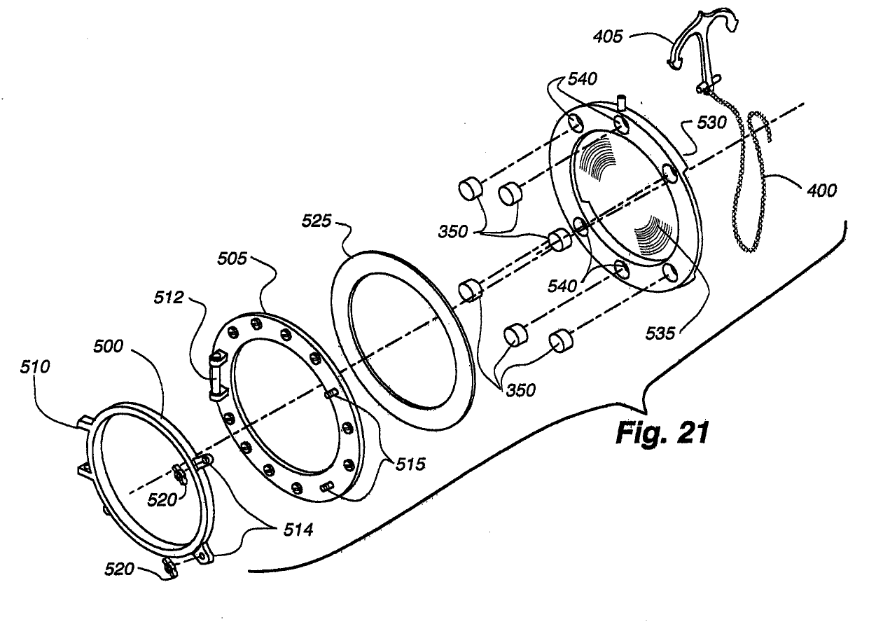

A metal ring 525 (see FIG. 21) may be secured to the back of the first base 505. The metal ring 525 may be glued, adhered, or mechanically fixed to the first base 505. The first window 500, first base 505, and so forth may be made of any suitable material, including plastic, metal, glass, wood, and so forth. In embodiments where the first base 505 is made of a metal (and particularly a metal susceptible to magnetic attraction), the metal ring 525 may be omitted.

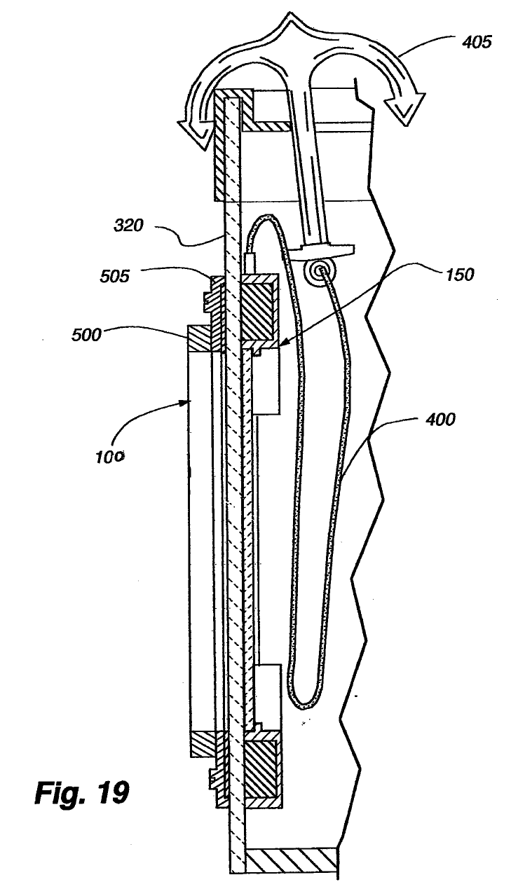

FIG. 19 is a cross-sectional view of the present embodiment taken along line 19-19 of FIG. 18. As shown in FIG. 19, the second viewing piece 150 is positioned on a side of the partition 320 opposite the first viewing piece 100. The second viewing piece 150 generally is molded or made from a plastic or glass. The second viewing piece 150 (see FIG. 21) has an outer, circular rim 530. The rim 530 may extend across only a portion of the second viewing piece's circumference, as shown in FIG. 21, or may extend along the entirety of the circumference. Essentially, the outer rim 530 may take the form of a first and second arcuate wing connected by first and second semicircular disc segments, as described above with respect to FIGS. 7 and 8. As yet another option, the rim 530 may consist of only the first and second arcuate wings.

With continued reference to FIG. 21, the interior portion of the second piece may be generally flat, in contrast to the convex lenses described above with respect to other embodiments. This interior portion may be, for example, a Fresnel lens 535, and thus may provide magnifying properties permitting a user to view a magnified portion of the environment.

As shown in FIG. 21, the outer rim 530 of the second viewing piece 150 may include one or more depressions 540 formed therein. Each such depression 540 may accept a magnet 350, which may be glued, adhered, or otherwise fastened to the second viewing piece 150. Typically, although not necessarily, the depressions 540 are formed on the side of the rim 530 abutting the partition.

The magnet or magnets 350 generally exert sufficient magnetic force to attract the metal rim 525 of the first viewing piece 100. Further, the magnetic attraction between the magnets 350 of the second viewing piece 150 and metal rim 525 of the first viewing piece 105 is sufficient to trap the partition therebetween and hold the first and second viewing pieces 100, 150 in place (possibly in conjunction with friction between the partition and first and second pieces).

An anchor or stay 405 may be attached by a line 400 to the second viewing piece 150, as shown in FIG. 19. The anchor 405 (or other stay) may be affixed or placed over a top of the partition 320. A user may remove the second viewing piece 150 from the environment by pulling on the line 400. In this manner, the user may remove the second viewing piece 150 without necessarily placing his or her hand into the environment.

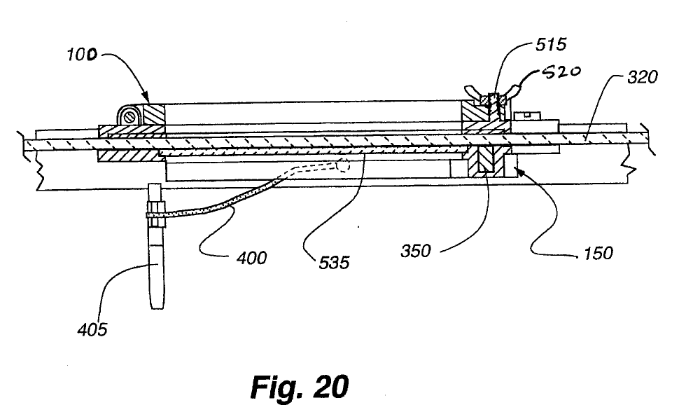

FIG. 20 is a cross-sectional view taken along line 20-20 of FIG. 18. The cross sectional view of FIG. 20 depicts, for example, the relationship between the wing nuts 520 and the wing nut studs 515. FIG. 20 also shows the magnets 350 abutting the partition 320. As described in more detail above, the magnets 350 attract the metal ring 525 (or metal) of the first viewing piece 100 to maintain the position of the first viewing piece 100 relative to the second viewing piece 150 when separated by the partition 320.

It should be noted that all directional references set forth herein (e.g., upper, lower, upward, downward, left, right, leftward, rightward, top, bottom, above, below, vertical, horizontal, clockwise, and counterclockwise) are relative and only used for identification purposes to aid the reader's understanding of the embodiments of the present invention, and are not limitations, particularly as to the position, orientation, or use of the invention unless specifically set forth in the claims. References to any joinder of elements (e.g., attached, coupled, connected, joined, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

We claim:

1. An apparatus for viewing an environment, comprising:
a first viewing piece defining a first viewport;
a second viewing piece defining a second viewport;
a mechanism operably connecting the first and second viewing pieces; wherein
at least one of the first and second viewing pieces magnifies at least a portion of the environment; and
the first viewport at least partially aligns with the second viewport.

2. The apparatus of claim 1, wherein the mechanism comprises a bracket joined to the first viewing piece and the second viewing piece.

3. The apparatus of claim 2, wherein the bracket comprises a first arm joined to the first viewing piece, a second arm joined to the second viewing piece, and a back connecting the first arm to the second arm.

4. The apparatus of claim 3, wherein at least of the first and second arms are releasably joined to the back.

5. The apparatus of claim 3, wherein at least one of the first and second viewing pieces are movable relative to the back.

6. The apparatus of claim 2, wherein the bracket is generally U-shaped.

7. The apparatus of claim 1, further comprising:
a line joined to at least one of the first and second viewing pieces; and
a stay joined to the line.

8. The apparatus of claim 7, wherein the mechanism comprises magnetic attraction between the first and second viewing pieces.

9. The apparatus of claim 8, wherein at least one of the first and second viewing pieces includes at least one magnet.

10. The apparatus of claim 1, wherein at least one of the first and second viewing pieces comprises a base and a window frame joined by a hinge to the base.

11. The apparatus of claim 10, wherein the window frame at least partially defines the viewport of the at least one of the first and second viewing pieces.

12. An apparatus for viewing an environment, comprising:
a first viewing piece defining a first viewport;
a line connected to the first viewing piece; and
a stay connected to the line and selectively connectable to a partition at least partially defining the environment; wherein:
the first viewing piece magnifies at least a portion of the environment; and
the line and stay maintain the first viewing piece in a stationary position relative to the partition.

13. The apparatus of claim 12, wherein the stay defines an anchor.

14. The apparatus of claim 13, wherein the stay is configured for attachment to an upper edge of the partition.

15. The apparatus of claim 12, wherein the stay is a suction cup.

16. The apparatus of claim 12, wherein a length of the line from the stay to first viewing piece may be selectively varied to change the stationary position of the first viewing piece relative to the partition.

17. A method for viewing an object in an environment defined by a partition, comprising:
obtaining a viewing apparatus comprising a first viewing piece defining a first viewport and a second viewing piece defining a second viewport, a bracket operably connecting the first and second viewing pieces, and at least one of the first and second viewing pieces magnifies at least a portion of the environment;
at least partially aligning the first viewport with the second viewport; and
placing at least one of the first and second viewing pieces in the environment.

18. The method of claim 17 further comprising, supporting the bracket by the partition defining the environment.

19. The method of claim 17, wherein at least partially aligning the first view piece to the second view piece includes moving at least one of the first and second viewing pieces relative to the bracket.

20. The method of claim 17 further comprising, changing an elevation of at least one of the first and second viewing pieces relative to the environment by moving the at least one of the first and second viewing pieces relative to the bracket.
